(19) United States
(12) Patent Application Publication
(10) Pub. No.: US 2024/0253161 A1
(43) Pub. Date: Aug. 1, 2024

(54) SYSTEMS AND METHODS TO CONTROL LASER APPLICATION FOR HANDHELD LASER WELDING TORCHES AND LASER WELDING EQUIPMENT

(71) Applicant: Illinois Tool Works Inc., Glenview, IL (US)

(72) Inventors: Shuang Liu, Appleton, WI (US); Andrew Pfaller, Hilbert, WI (US); Todd E. Holverson, Appleton, WI (US); Steven B. Massey, JR., Appleton, WI (US); Joseph C. Schneider, Greenville, WI (US); Bruce Patrick Albrecht, Neenah, WI (US); William R. Giese, Monee, IL (US)

(21) Appl. No.: 18/427,667

(22) Filed: Jan. 30, 2024

Related U.S. Application Data
(60) Provisional application No. 63/482,555, filed on Jan. 31, 2023.

(51) Int. Cl. B23K 26/24; B23K 9/10; B23K 26/03; B23K 26/06; B23K 26/082; B23K 37/02

(52) U.S. Cl. CPC B23K 26/24; B23K 9/1093; B23K 26/03; B23K 26/0626; B23K 26/082; B23K 37/0205

(57) ABSTRACT

Systems and methods for laser welding are disclosed. A laser welding system includes a manually operated laser welding torch to direct laser power to a workpiece to generate a puddle during a laser welding operation. The welding system includes a controller to regulate activation and regulation of the laser power based on user inputs, sensor inputs, and/or synergic control of a laser power source.

### CROSS REFERENCE TO RELATED APPLICATIONS

This application is a Non-Provisional Patent Application claiming priority to U.S. Provisional Patent Application No. 63/482,555 entitled “Systems And Methods For Laser Welding And Laser Welding Equipment” filed Jan. 31, 2023, which is herein incorporated by reference in its entirety.

### BACKGROUND

Welding is a process that has historically been a cost effective joining method. Welding is, at its core, a way of bonding two pieces of parent material. Laser welding is a welding technique used to join multiple pieces of metal through the use of a laser. The laser beam provides a concentrated heat source, enabling a precise control of the heat input and high welding speed, creating a weld with low heat input, and a small heat affected zone. In various applications, filler metal may be needed for different purposes such as filling a gap between workpieces, reinforcing the joint, overlaying a substrate surface, building up an object, or acting as a buffering medium.

Conventional laser-based welding tools can create challenges for new users, especially for manually operated laser welders. Even welders with long experience with arc-related welding systems may be unfamiliar with the peculiarities of a laser welding system, including how to achieve a quality weld bead and incorporate laser protection features. Thus, systems and/or methods that facilitate and stabilize welding from laser based welding systems with laser protection features is desirable.

### SUMMARY

This disclosure relates generally to laser welding systems, methods, and apparatuses. More particularly, this disclosure relates to manually operated laser welding systems and torches, which may employ a continuously fed electrode wire for use in laser welding processes, substantially as illustrated by and described in connection with at least one of the figures, as set forth more completely in the claims.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 illustrates an example laser type welding system, in accordance with aspects of this disclosure.

FIGS. 2A-2C illustrate example wobble patterns applied by the laser welding system of FIG. 1, in accordance with aspects of this disclosure.

The figures are not necessarily to scale. Wherever appropriate, similar or identical reference numerals are used to refer to similar or identical components.

### DETAILED DESCRIPTION

Disclosed example systems and methods for laser welding are provided. In particular, disclosed example laser welding systems include a manually operated laser welding torch to direct laser power to a workpiece to generate a puddle during a laser welding operation. The welding system includes a controller to regulate activation and regulation of the laser power based on user inputs, sensor inputs, and/or synergic control of a laser power source.

In disclosed examples, a laser welding system includes a laser source to generate laser power to perform a welding operation; a handheld laser welding torch to direct the laser power to a workpiece via a nozzle, wherein the nozzle is configured to output a laser beam; and a laser beam controller to control application of the laser beam from the handheld laser welding torch to the workpiece as a focal point following one or more wobble movements defining a wobble path, the one or more wobble movements being coordinated with the laser power relative to a position of a focal point at the workpiece along a wobble path.

In some examples, the laser beam controller applies the wobble movements in a forward-backward movement based on a lateral line relative to the nozzle, and a side-to-side movement relative to a reference line or point associated with a direction of travel or a joint.

In examples, the laser beam controller applies the forward-backward movement at a first frequency, and applies the side-to-side movement at a second frequency different from the first frequency.

In examples, the first frequency is less than the second frequency.

In examples, the laser beam controller applies the side-to-side movement to extend a first distance from the reference line or point at a first side, and extend a second distance from the reference line or point at a second side opposite the first side, wherein the first distance is different from the second distance.

In examples, the laser beam controller applies the side-to-side movement to move from the reference line or point to first side and back over a first period of time, and move from the reference line or point to the second side over a second period of time, wherein the first period of time is different from the second period of time.

In some examples, the laser beam controller applies the one or more wobble movements as one or more of a circle, an ellipse, a zigzag, a figure 8, a transverse reciprocating line, a crescent, a triangle, a square, a rectangle, a bracket shape, plus sign, carat, S-shape, $-shape, a non-linear pattern, an asymmetrical pattern, a pause, as a non-limiting list of examples, or any combination thereof

In some examples, the laser welding system further includes a laser controller configured to receive one or more characteristics associated with a joint, a workpiece material, a welding application, wire material, or welding process; and control the laser beam controller to move the laser beam based on the one or more characteristics.

In examples, the laser beam controller comprises one or more optics mounted to the handheld laser welding torch and configured to control movement of the laser beam at the workpiece.

In some examples, the laser welding system further includes a wire heater to preheat the wire prior to application of the laser beam to the wire.

In examples, the laser controller is further configured to control a heat output of the wire heater based on the one or more wobble movements.

In examples, the laser beam controller directs the wobble path to scan a portion of a welding wire prior to the welding wire making contact with the workpiece or a weld puddle at the workpiece.

In some examples, the laser welding system further includes a laser controller configured to receive one or more inputs associated with wire feed speed or wire type; and control the laser beam controller to adjust application of the laser beam based on the one or more inputs.

In examples, adjusting the application of the laser beam includes adjusting a width or an intensity of the laser beam.

In some disclosed examples, a laser welding system includes a laser source to generate laser power to perform a welding operation; a handheld laser welding torch to direct the laser power to a workpiece via a nozzle, wherein the nozzle is configured to output a laser beam; a laser beam controller to control application of the laser beam from the handheld laser welding torch to the workpiece as a focal point following one or more wobble movements defining a wobble path, the one or more wobble movements being coordinated with the laser power relative to a position of a focal point at the workpiece along the wobble path; and a sensor to measure one or more weld characteristics of a weld bead or the workpiece.

In some examples, the laser welding system further includes a laser controller to receive measurements of the one or more weld characteristics from the sensor; compare the one or more weld characteristics to a list of weld characteristics associated with one or more predetermined operational parameters of the laser welding system; identify a predetermined operational parameter of the one or more predetermined operational parameters based on the comparison; and control operation of the laser beam controller or the laser source in accordance with the predetermined operational parameter.

In some examples, the one or more predetermined operational parameters include a desired pattern for applying the laser beam to the workpiece.

In examples, the one or more predetermined operational parameters include a power output for the laser source.

In some examples, the one or more weld characteristics include a temperature, size, color, angle, gap, orientation, material thickness, or shape of the weld bead or the workpiece.

In some disclosed examples, a collaborative robot laser welding system includes a laser source to generate laser power to perform a welding operation; a handheld laser welding torch to direct the laser power to a workpiece; and a robotic arm to support the handheld laser welding torch. The system includes a laser controller to receive a first input from a user corresponding to position or movements of the collaborative robot; receive a second input corresponding to a welding process; and control generation of the laser power from the laser source and the positions or the movements of the robotic arm based on the first and second inputs.

In some examples, the collaborative robot laser welding system further includes a user interface configured to present and receive selection of the first or second inputs, wherein the second input corresponds to a power output for the laser source, a joint type, a workpiece material, a welding application, a wire material, or a welding process.

As used herein, the word “exemplary” means serving as an example, instance, or illustration. The examples described herein are not limiting, but rather are exemplary only. It should be understood that the described examples are not necessarily to be construed as preferred or advantageous over other examples. Moreover, the term “examples” does not require that all examples of the disclosure include the discussed feature, advantage, or mode of operation.

As used herein, a wire-fed welding-type system refers to a system capable of performing welding (e.g., gas metal arc welding (GMAW), gas tungsten arc welding (GTAW), etc.), laser beam welding (LBW—the process by which materials are fused together by laser light from a laser source), brazing, cladding, hardfacing, cleaning, ablating, and/or other processes, in which a filler metal is provided by a wire that is fed to a work location, such as an arc or weld puddle.

As used herein, the term “welding-type operation” includes a welding operation employing a laser welding systems using laser energy, operable to fuse, bind, clean and ablate, and/or cut one or more materials and/or layers of materials.

As used herein, a welding-type power source refers to any device capable of, when power is applied thereto, supplying welding, cladding, plasma cutting, induction heating, laser (including laser welding and laser cladding), carbon arc cutting or gouging and/or resistive preheating, including but not limited to transformer-rectifiers, inverters, converters, resonant power supplies, quasi-resonant power supplies, switch-mode power supplies, etc., as well as control circuitry and other ancillary circuitry associated therewith.

As used herein, a cobot, or collaborative robot, is a robot intended for direct human-robot interaction within a shared space, or where humans and robots are in close proximity Cobot applications contrast with traditional industrial robot applications in which robots are isolated from human contact.

For the purpose of promoting an understanding of the principles of the claimed technology and presenting its currently understood best mode of operation, reference will be now made to the examples illustrated in the drawings, and specific language will be used to describe the same. It will nevertheless be understood that no limitation of the scope of the claimed technology is thereby intended, with such alterations and further modifications in the illustrated device and such further applications of the principles of the claimed technology as illustrated therein being contemplated as would typically occur to one skilled in the art to which the claimed technology relates.

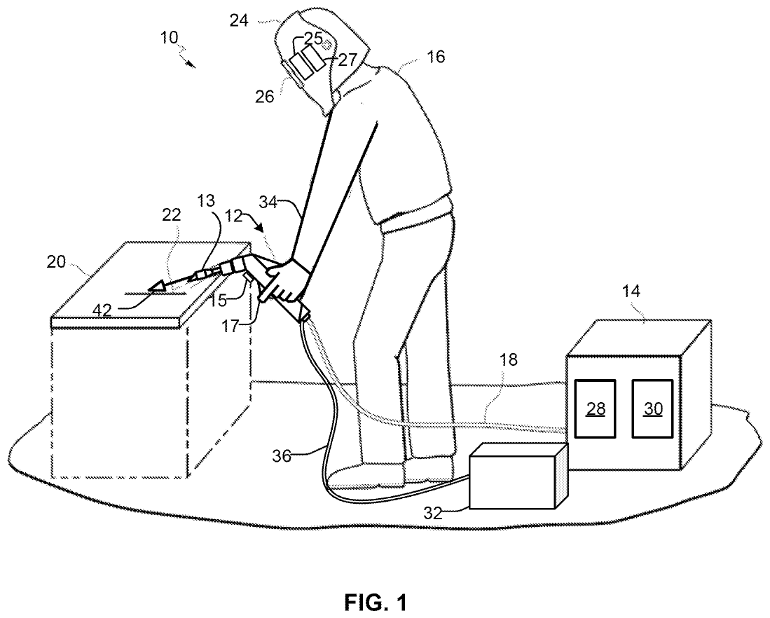

FIG. 1 is a schematic diagram of an example laser welding system 10. The example laser welding system 10 of FIG. 1 includes a laser welding power supply 14, a laser power source 28, a laser controller 30 (e.g., a processing circuitry, control circuitry, memory circuits, interface and/or communication circuitry, etc.), and a wire feeder 32. A handheld laser welding torch 12 is connected to the power supply 14 via power cable 18, and receives wire 36 from the wire feeder 32. In some examples, the handheld laser welding torch 12 includes one or more of a nozzle 13, one or more user input devices 17 (e.g., a trigger, a knob, switch, graphical interface, interlock, etc.), and/or one or more sensors 15 (e.g., an accelerometer, an inertial measurement unit (IMU), a gravimeter, a laser scanner, a wireless transceiver, an ultrasound sensor, a mechanical sensor, temperature sensor, a magnetometer, a gyroscope, an optical sensor, an electrical sensor, etc.).

The laser source 28 generates welding-type laser power to output a laser beam 42 (e.g., directed light energy) based on input power received from the power supply 14. The laser source 28 may be a light emitting a CO₂ laser, Nd:YAG laser, diode-type laser, fiber laser, disk laser or any other type of laser generator. As used herein, welding-type lasing power refers to laser power having wavelength(s) that are suitable for delivering energy to metal for welding, cutting, and/or cladding. Laser cleaning operations (e.g., laser ablation) are also conducted by directing one or more laser beams on the workpiece. For instance, the handheld laser welding torch 12 scans the laser beam across the workpiece to remove unwanted material (e.g., metal particulates, spatter, etc.).

An operator 16 can wear one or more of a wearable 34 (such as a glove, a smartwatch, etc.) and/or a helmet and/or glasses 24 to protect the welder's eyes and skin, for instance. In some examples, the helmet 24 includes a screen 26, which may be configured to automatically dim when exposed to intense light, may be a filter for one or more wavelengths (e.g., ultraviolet, infrared, etc.), and/or may be connected to another part of the system (e.g., controller 30). This allows the screen 26 to present information to the operator 16 to inform the welding process. Helmets and glasses are often used during a welding operation, including set up of the welding station, calibration, and/or to oversee automated (e.g., robotic) welding operations. In a laser welding application, the shaded lens of glasses and helmets may provide a degree of protection from direct laser light and/or light reflected from a workpiece. Protective clothing provides a degree of protection from high intensity beams, spatter, etc.

The torch 12 focuses the laser power as a beam 42 at a joint, seam, surface, or weld 22 on a workpiece 20. The laser power 42 heats the workpiece 20 to generate a puddle during welding operations. The wire feeder 32 feeds the wire 36 (e.g., filler wire, cladding material, metal additive) to the puddle generated by the laser beam 42. The wire 36 melts into the puddle in the weld 22. The wire 36 may be fed from a wire supply, such as a wire reel or wire supply drum, and may be conveyed through a cable or other suitable conduit.

During a welding process, the laser controller 30 controls a focal point of the laser beam to wobble in multiple axes as applied to the workpiece 20. By moving the focal point in multiple directions, the laser can induce one or more beneficial effects in the weld. Examples of such beneficial effects that can be induced in the lateral direction(s) include agitating or stirring of the puddle laterally (including in patterns) to improve filler mixing, creating a heat gradient in the puddle in at least a partially lateral direction to induce movement and improve puddle wetting, and/or controlling the heating and/or cooling rates of the puddle in at least a partially lateral direction by controlling where heat is concentrated. The changing wobble patterns can be configured to adjust power distribution and to change a penetration profile of the laser.

In some examples, movement of the laser beam is controlled such that side-to-side motion is variable, random, and/or has multiple changing directions, angles, and/or lengths. For instance, side-to-side movement of the focal point may promote gap filling, wetting at the toes of a workpiece, penetration profile, etc., and may be set to a high wobble frequency (e.g., greater than 100 wobbles/movements per second). The location, movement, size and/or intensity of the laser beam itself (e.g., spot size, power output) and/or the wobble pattern (e.g., scanning pattern, frequency, etc.) can change the penetration profile and/or weld bead quality. In some non-limiting examples, the focal point and depth for a 3-5 mm spot size may be appropriate for materials at half an inch or thicker, and changes thereof will affect the depth and weld profile, which may be appropriate for different applications.

An additional, possibly independently controlled forward-backward motion at a lower wobble frequency could be used to result in a substantially rippled appearance, similar to a traditional ripple look of tungsten inert gas (TIG) welds, and/or other desirable characteristics.

The laser beam 42 can be controlled in any desired pattern, which may include, but is not limited to, a pattern with one or more straight lines and/or one or more curves. In some embodiments, the desired pattern may include a pause or break in the pattern, such as a time interval in which the focal point does not move. The desired pattern may include a circle, an ellipse, a zigzag, a figure 8, a transverse reciprocating line, a crescent, a triangle, a square, a rectangle, a non-linear pattern, an asymmetrical pattern, a pause, or any combination thereof. As may be appreciated, a pattern or a combination of patterns may be used and optimized for particular welds and/or welding positions. The movement of the focal point and the relative movement between the workpiece 20 and the laser torch 12 causes the focal point to trace a superimposed pattern over the workpiece 20. The example pattern may be traced by the laser beam 42 to agitate the puddle.

### Laser Welding System Control

In some laser welding systems, “wobble” of the laser beam can impact weld consistency. The laser beam tends to oscillate or reciprocate in one or two dimensions as the weld progresses. The wobble is often characterized by a shape and/or pattern (e.g., a zig-zag pattern, helical, circular, triangular, rectangular, etc.) or applied randomly, which can be controlled by optics of the laser welding system. Further, application of laser power (e.g., intensity, pulse frequency) can be coordinated with a wobble pattern or path, to provide a desired output and/or weld bead. For example, the wobble pattern or wobble path reflects the focus or focal point of the laser beam on the workpiece, as being directed by an optic (e.g., a lens, a mirror, a galvanometer, etc.).

Wobble configuration can be designed to balance heat in at the weld bead, work piece, and/or wire, in coordination with power application. For example, different joints, different workpieces types, different applications (e.g., introduction of a filler wire), use of hotwire preheating, travel speed, wire feed speed, and/or type of wire (as a list of non-limiting examples) can change an amount of heat or distribution of that heat required to perform the weld. Thus, coordination of wobble characteristics with the application of power from the laser power source can simplify the welding process and enhance the quality of the weld.

The wobble pattern (including a speed, direction, intensity, distance of the laser scan) can be correlated with a wire feed speed, as wire feed speed may contribute to travel speed of the handheld laser welding torch. This correlation can be programmed into the laser power generator, the laser controller, and/or the wire feeder. In some examples, the correlation is preset, but there is no communication between the wire feeder and the laser controller.

In some examples, an initial wobble pattern can be implemented to heat up a cold workpiece until certain conditions are met (e.g., for a preset amount of time, for a predetermined number of wobble pattern cycles, and/or once the workpiece achieves a threshold temperature level). For example, the wobble pattern may deviate from the reference line(s) and/or reference point by a first amount, which changes to a second amount after one or more of the conditions are met. Additionally or alternatively, the laser beam can have a different (e.g., lower) intensity and/or a different (e.g., larger) spot size initially to ramp up heating of the workpiece.

This and other wobble patterns may be selected based on types of joints or workpieces, and may have one set movements if being used without a welding wire versus applications employing filler wire.

An example wobble application includes the laser beam controller applying the laser focal beam wobble movements in a forward-backward movement (e.g., based on a lateral line relative to the direction of travel and/or the weld), and in a side-to-side movement relative to a reference line 106. The wobble movements can be controlled to follow one or more wobble patterns or wobble paths, a position of the a focal point of the laser beam at the workpiece along the a wobble path

For example, the reference line 106 can be a centerline associated with a direction of travel of the hand held welding torch, a line aligned with a seam or joint (e.g., collinear with the joint or parallel to the joint). The reference line 106 represents a neutral line along the weld path, where a wobble cycle starts, repeats, and/or crosses during a wobble cycle (e.g., a zero crossing). Thus, amount of movement of the focal point of the laser beam in a side-to-side movement is determined/calculated based on the position of the reference line 106.

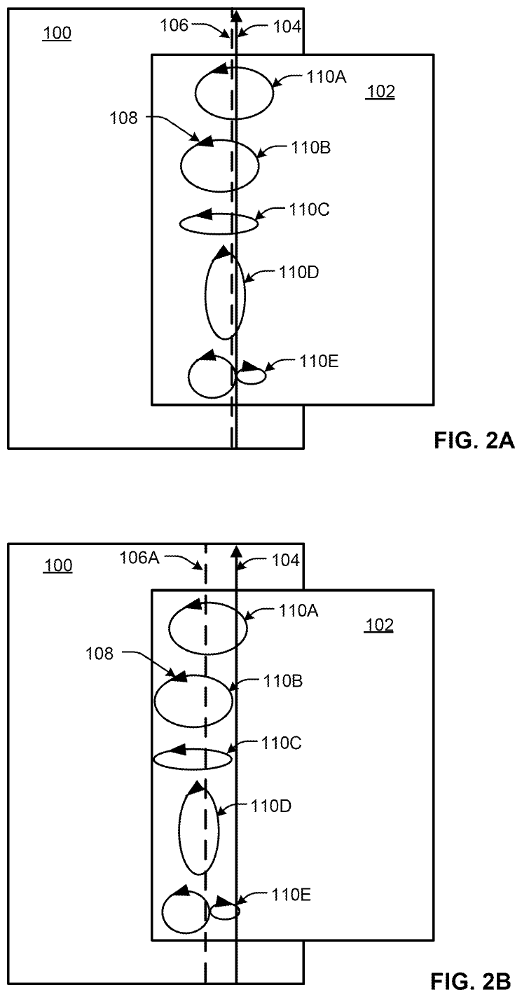

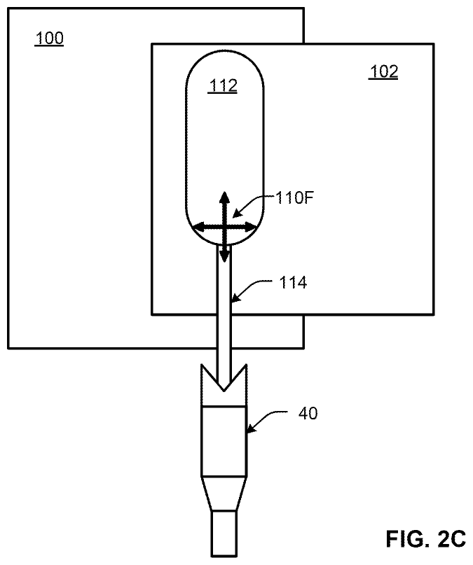

In some examples, the reference line 106 is collinear with the weld path 104, as shown in FIG. 2A. In other examples, the reference line 106 is off-center relative to the weld path 104, as shown in FIG. 2B.

In the example of FIGS. 2A-2C, the laser beam controller applies the forward-backward movement of the wobble patterns 110A-110F at a first frequency, and applies the side-to-side movement at a second frequency. In some examples, the first and second frequencies are the same (e.g., substantially circular), whereas in some examples the second frequency is different from the first frequency. As shown, the wobble pattern 110A is generally circular, yet may appear compressed along the direction of travel due to movement of the handheld laser welding torch 12 and/or wire 114.

Wobble pattern 110B is substantially similar to wobble pattern 110A, but is offset relative to the reference line 106. Thus, the laser beam 42 dwells over the left side for a longer amount of time than the right side, thereby applying greater amount of heat to the first workpiece 100. Wobble pattern 110C has a greater frequency in the side-to-side motion, thereby compressing the front-to-back profile of the pattern. Wobble pattern 110D has a greater frequency in the front-to-back motion, thereby compressing the side-to-side profile of the pattern.

Wobble pattern 110E follows a figure-8 pattern, with a larger circular movement on the left side than the right side. This results in added heat to the first workpiece 100 relative to the second workpiece 102.

This can be accomplished by controlling the focal point 108 with side-to-side movements that move from the centerline to first side (e.g., over the first workpiece 100) and back over a first period of time, and move from the centerline to the second side (e.g., over the second workpiece 102) over a second period of time. Although shown as being different in the example of the wobble patterns 110B-110E, the first and second periods of time can be equal, as shown in the wobble pattern 110A.

The laser beam controller can apply the wobble patterns in a variety of movements, including combining two or more different movements. The wobble patterns include one or more of a circle, an ellipse, a zigzag, a figure 8, a transverse reciprocating line, a crescent, a triangle, a square, a rectangle, a bracket shape, plus sign, carat, S-shape, $-shape, a non-linear pattern, an asymmetrical pattern, a pause, as a non-limiting list of examples, or any combination thereof.

Thus, increasing the wobble cycle frequency can change the distribution of the laser beam energy on the workpieces. Similarly, an amount of time the wobble pattern dwells over the workpieces and/or portions of the workpiece correlates to the heat distribution.

In addition to or in the alternative to frequency or speed, the laser beam controller applies the side-to-side movement to extend a first distance from the centerline at a first side, and extend a second distance from the centerline at a second side opposite the first side, wherein the first distance is different from the second distance.

Although some examples illustrate the reference line 106 as being parallel with the weld path 104, in other examples the reference line 106 is at an angle relative to the weld path 104. Further, although illustrated as a straight line, one or more parts of the reference line 106 may curve and/or change direction, depending on sensor feedback (e.g., temperature, weld bead characteristics, etc.), and/or weld process instructions (e.g., wire type, workpiece materials, joint type, wire feed speed, travel speed, etc.).

An example where the first workpiece 100 has a first thickness or material type and the second workpiece 102 has a second thickness and/or material type, the wobble can be applied to apply heat to enhance fusion. The first workpiece 100 may be thicker or have a more robust material compared to the second workpiece 102, therefore more heat may be applied to the first workpiece.

In some examples, the laser controller is configured to automatically transition in and/or out of a wobble pattern in response to one or more identified features and/or sensor inputs. For example, if the system recognizes a transition between two particular types of joints (e.g., a lap joint to a T-joint), the wobble pattern may be transitioned from a first wobble pattern to a second wobble pattern, to accommodate the changing position and/or orientation of the workpieces. The transition can be predetermined (e.g., included as part of a weld schedule) and/or in response to sensor input (e.g., a scan of the weldment).

The disclosed laser system can further be implemented to promote heating of the wire. As shown in the example of FIG. 2C, the wobble pattern 110F can be controlled to scan the focal point 108 in a wobble path such that the focal point 108 extend to a portion of a welding wire 114 prior to making contact with the workpieces or a weld bead/weld puddle 112.

In the example illustrated in FIG. 2C, the wobble pattern 110F is controlled such that the focus of the laser beam is moved along the welding wire 114 to at energy from the laser to preheat the welding wire 114. The movement of the focal point may be different than other movements, such that the focal point dwells on the wire for a shorter distance and/or period of time than other movements (e.g., relative to the reference line and/or point). Further, the frequency of the movements onto the welding wire 114 may be higher than other movements (e.g., forward along the weld bead 112, side-to-side within the weld bead 112). Thus, the wire 114 is heated to a temperature below the melting point of the wire. This ensures the wire retains a level of stiffness as it is introduced to the weld bead 112, but requires less heat applied to the weld bead 112 to encourage melting.

In some examples, the laser welding system includes a wire heater to preheat the wire in advance of contacting the weld puddle and/or the workpiece. Thus, laser characteristics (e.g., power, intensity, spot size, wobble pattern, etc.) can be adjusted based on wire heater power and/or a temperature of the workpiece or wire. The wobble pattern may be adjusted to introduce less heat into the weld puddle when employing a wire heater. The wobble patterns may include those disclosed herein that better distribute heat.

The laser welding system may further include one or more sensors to inform the laser controller in applying a wobble pattern. For example, the laser controller is configured to receive one or more characteristics associated with a joint, a workpiece material, a welding application, wire material, or welding process; and control the laser beam controller to move the laser beam based on the one or more characteristics.

The changing wobble patterns can be configured to adjust power distribution and to change a penetration profile of the laser. With the use of sensor, the changes can be implemented dynamically, such that changes can be made in response to sensor data reaching or exceeding certain threshold values. For instance, if the temperature at a portion of the workpiece is above or below a desired temperature or temperature range, the wobble pattern can change distribution (e.g., relative to the reference lines or point), and/or frequency, dwell time, etc. The changes in the wobble pattern can be coordinated with and/or independent of laser output (e.g., intensity, spot size, power, etc.).

In some examples, the laser beam controller includes one or more optics mounted to the handheld laser welding torch and configured to control movement of the laser beam at the workpiece.

The optics can include a galvanometer or other such device configured to manipulate (e.g., deflect) laser beams by use of lenses and/or minors. In particular, a galvanometer senses an electric current and adjusts direction/application of the laser beams in response. A galvanometer system uses the minor to move the laser beam in different directions by rotating and/or adjusting the angles of the minors to direct the focal point on the workpiece. In some examples, the galvanometer can be incorporated with the handheld laser welding torch.

Several advantages stem from the movement of the laser beam. For example, compared to a heating profile and cooling rate of a fixed beam laser, the heating profile is more distributed, and the cooling rate is increased in the weld puddle created by the moving laser beam.

Some wobble patterns and/or laser power profiles demonstrate enhanced effectiveness for some welding operations. For instance, which wobble pattern to apply may be informed by one or more features of the workpiece (e.g., thicknesses, material type, joint type, joint orientation), as well as the characteristics of the welding system (e.g., rated power output, type of laser, etc.). Thus, based on one or more inputs (received via a user interface and/or via sensor), the wobble can be adjusted for different workpieces, welds, and/or locations speed within the weld. The adjustments can include the width and intensity of the laser beam, as well as the dimensions and speed with which the wobble pattern is applied.

In some examples, asymmetric wobble of the laser is used to compensate for drift of the laser focal point. This approach can also be used to improve aim and/or accommodate differences in a workpiece thickness. As a result, at one or more locations along the weld, the power and/or time of the wobbled laser may be controlled to be higher and/or lower on one side or another along the weld.

In an example, the profile pulse goes up and down, resulting in a desired aesthetic for the weld bead (e.g., a “stack of dimes” presentation). The movement of the beam and changes in the wobble pattern can cause stirring of the molten weld, creating a temperature gradient therein.

In some examples, the wobble pattern control described herein can be applied to laser cleaning operations. For instance, the handheld laser welding torch 12 scans the laser beam across the workpiece in accordance with one or more wobble patterns 110A-F to remove unwanted material (e.g., metal particulates, spatter, etc.). The particular wobble pattern applied may be selected

In some examples, welding power can be adjusted during the welding operation by using an external control device (e.g., an accessory and/or remote control similar to TIG welding control), such as by varying one or more characteristics of the laser beam (e.g., laser power, wobble profile, pulse frequency, step function, etc.). This adjustment can be implemented via a remote foot control pedal, a fingertip device, a strain gauge, a pressure strip, audible controls, etc.

### User Interfaces and Automatic Control of Laser Welding Systems

In some examples, the welding system includes one or more features allowing an operator to input (e.g., via a user interface) one or more welding parameters (e.g., application type, wire type, workpiece type, workpiece thickness, joint type, joint orientation, etc.) and the welding system automatically adjusts one or more of the other welding parameters (e.g., an “autoset” feature).

In disclosed examples, the autoset feature is configured to receive standard welding parameter input (e.g., associated with mechanical parameters such as joint type, joint orientation, material type, workpiece thickness, gas type, etc.) and convert those parameters to laser parameters related to laser welding, such as beam wobbling width, beam wobbling pattern, beam wobbling frequency, laser power output, laser pulse frequency, and/or wire feed speed, as a list of non-limiting examples. The conversion and/or association of standard welding parameters to laser welding parameters can be stored in a list of welding parameters, received via an operator input, and/or calculated or otherwise determined by use of one or more algorithms (e.g., machine learning and/or artificial intelligence).

In some examples, the laser welding parameters are used as an input upon which other welding parameters (standard or laser focused) are adjusted. Further, based on a selection from the operator as to the weld operation or workpiece, the system can adjust one or more welding parameters based on known properties of the workpiece (e.g., dimensions, material type, thickness, etc.) and changes to the welding parameters (e.g., wire feed speed, travel speed, laser power, etc.) during a welding operation (e.g., in response to an operator selection).

In some examples, the laser welding torch is configured to output a laser beam(s) in accordance with a given profile for a given welding operation. For instance, a first laser profile can be associated with a first frequency of high and low pulses and/or a first wire feed speed, to provide a desired weld bead output for a first welding operation. A second laser profile can be associated with a second frequency of high and low pulses and/or a second wire feed speed, to provide a desired weld bead output for a second welding operation. The system can automatically transition between first and second laser profiles based on one or more sensor measurements, and/or in response to an input from the operator. Example laser welding operations can correspond to joining or cutting operations, a type of weld or joint, joint orientation, and/or a type of material, as a list of non-limiting examples. Although referenced as discrete values, any profile value (e.g., frequency, pulse energy, wire feed speed, etc.) can be adjusted dynamically and/or based on a user input.

In some examples, one or more welding parameters may meet physical or other limitations that may impact transition between first and second parameter values. For instance, changes to power characteristics (e.g., voltage) may be much quicker than to wire feed speed, due to the time to adjust motor speed. Thus, the rate and/or time to enact the transition may be delayed for a given amount of time, in response to some trigger (e.g., the lagging parameter achieving a given value, position, etc.), or in accordance with a value provided by the operator.

In some disclosed examples, the disclosed handheld laser welding torch is configured to be used with a collaborative robot, or cobot. For example, the cobot can be configured to support, manipulate and/or control the handheld laser welding torch. This includes mounting the torch in a robotic arm controlled by the cobot, which can position the torch in accordance with a programmed welding operation. The cobot can further activate the torch and implement a welding operation, including by activating one or more wobble patterns, as disclosed herein.

In an example welding operation, the cobot includes and/or is connected to a laser source to generate laser power to perform a welding operation. The handheld laser welding torch is mounted to the cobot and manipulated to direct the laser power to a workpiece (e.g., from the nozzle). The laser controller is configured to receive a first input from a user corresponding to position or movements of the collaborative robot (e.g., by training the cobot to implement the welding operation), and to receive a second input corresponding to a welding process, such as a power output, wobble pattern, joint or workpiece type, etc. Based on the inputs, the controller controls the laser power from the laser source and manipulates the torch to (e.g., via the robotic arm) based on the first and second inputs.

In some example, a user interface is configured to present and receive selection of one or more of the first or second inputs. For instance, the first input can correspond to a position or orientation of the torch along the weld path, and the second input can correspond to a power output for the laser source, a joint type, a workpiece material, a welding application, a wire material, or a welding process.

### Synergic Control of Laser Welding Systems

In some example systems, one or more welding parameters can be regulated by synergic control, such that two or more welding parameters are adjusted based on a common or related input. For instance, a change in laser power may impact wire feed speed. In some examples, the pulse frequency, power level, travel speed, etc., could be regulated via synergic control.

The synergically controlled parameters may be set at the power supply and/or dynamically controlled during the welding operation, automatically and/or by the operator, such as by using an analog trigger, foot pedal, or other adjustable-input device to receive operator input. Based on the input (e.g., an input representative of power output), the laser welding power supply may change the synergically controlled parameters in real-time to respond to the operator input and improve operator control over the result of the weld. In an example, syncing the power level of the laser beam and the wire feed speed provides a more consistent, higher quality weld. As a result, the weld bead provides the “stack of dimes” appearance, which provides a visual indication of weld quality.

For example, a limit can be placed on one or more of the welding parameters (e.g., power level) of the system by the user in order to minimize the chances of burn-through of the material (e.g., thin gauge), but the synergic control may still allow adjustability of one or more other, non-limited parameters to the operator to adjust other parameters (e.g. wire feed speed, pulse frequency, wobble rate, travel speed, etc.). The synergic control may automatically adjust one or more of the other parameters in response to the operator-adjusted parameter.

In some examples, one or more welding parameters can be locked (e.g., unable to be changed) or limited (e.g., any changes are limited to a predetermined range). For instance, a bank of laser welding power supplies can have one or more welding parameters set or calibrated by a supervisor, such that each power supply has a consistent functionality regardless of operator.

As utilized herein the terms “circuits” and “circuitry” refer to physical electronic components (i.e. hardware) and any software and/or firmware (“code”) which may configure the hardware, be executed by the hardware, and or otherwise be associated with the hardware. As used herein, for example, a particular processor and memory may comprise a first “circuit” when executing a first one or more lines of code and may comprise a second “circuit” when executing a second one or more lines of code. As utilized herein, “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”. As utilized herein, the term “exemplary” means serving as a non-limiting example, instance, or illustration. As utilized herein, the terms “e.g.,” and “for example” set off lists of one or more non-limiting examples, instances, or illustrations.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, systems, blocks, and/or other components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

What is claimed is:

1. A laser welding system, comprising:
a laser source to generate laser power to perform a welding operation;
a handheld laser welding torch to direct the laser power to a workpiece via a nozzle, wherein the nozzle is configured to output a laser beam; and
a laser beam controller to control application of the laser beam from the handheld laser welding torch to the workpiece as a focal point following one or more wobble movements defining a wobble path, the one or more wobble movements being coordinated with the laser power relative to a position of a focal point at the workpiece along a wobble path.

2. The laser welding system of claim 1, wherein the laser beam controller applies the wobble movements in a forward-backward movement based on a lateral line relative to the nozzle, and a side-to-side movement relative to a reference line or point associated with a direction of travel or a joint.

3. The laser welding system of claim 2, wherein the laser beam controller applies the forward-backward movement at a first frequency, and applies the side-to-side movement at a second frequency different from the first frequency.

4. The laser welding system of claim 3, wherein the first frequency is less than the second frequency.

5. The laser welding system of claim 2, wherein the laser beam controller applies the side-to-side movement to extend a first distance from the reference line or point at a first side, and extend a second distance from the reference line or point at a second side opposite the first side, wherein the first distance is different from the second distance.

6. The laser welding system of claim 2, wherein the laser beam controller applies the side-to-side movement to move from the reference line or point to first side and back over a first period of time, and move from the reference line or point to the second side over a second period of time, wherein the first period of time is different from the second period of time.

7. The laser welding system of claim 1, wherein the laser beam controller applies the one or more wobble movements as one or more of a circle, an ellipse, a zigzag, a figure 8, a transverse reciprocating line, a crescent, a triangle, a square, a rectangle, a bracket shape, plus sign, carat, S-shape, $-shape, a non-linear pattern, an asymmetrical pattern, a pause, as a non-limiting list of examples, or any combination thereof.

8. The laser welding system of claim 1, further comprising a laser controller configured to:
receive one or more characteristics associated with a joint, a workpiece material, a welding application, wire material, or welding process; and
control the laser beam controller to move the laser beam based on the one or more characteristics.

9. The laser welding system of claim 8, wherein the laser beam controller comprises one or more optics mounted to the handheld laser welding torch and configured to control movement of the laser beam at the workpiece.

10. The laser welding system of claim 1, further comprising a wire heater to preheat the wire prior to application of the laser beam to the wire.

11. The laser welding system of claim 10, wherein the laser controller is further configured to control a heat output of the wire heater based on the one or more wobble movements.

12. The laser welding system of claim 11, further comprising a laser controller configured to:
receive one or more inputs associated with wire feed speed or wire type; and
control the laser beam controller to adjust application of the laser beam based on the one or more inputs.

13. The laser welding system of claim 12, wherein adjusting the application of the laser beam includes adjusting a width or an intensity of the laser beam.

14. A laser welding system, comprising:
a laser source to generate laser power to perform a welding operation;
a handheld laser welding torch to direct the laser power to a workpiece via a nozzle, wherein the nozzle is configured to output a laser beam;
a laser beam controller to control application of the laser beam from the handheld laser welding torch to the workpiece as a focal point following one or more wobble movements defining a wobble path, the one or more wobble movements being coordinated with the laser power relative to a position of a focal point at the workpiece along the wobble path; and
a sensor to measure one or more weld characteristics of a weld bead or the workpiece.

15. The laser welding system of claim 14, further comprising a laser controller to receive measurements of the one or more weld characteristics from the sensor;
compare the one or more weld characteristics to a list of weld characteristics associated with one or more predetermined operational parameters of the laser welding system;
identify a predetermined operational parameter of the one or more predetermined operational parameters based on the comparison; and
control operation of the laser beam controller or the laser source in accordance with the predetermined operational parameter.

16. The laser welding system of claim 14, wherein the one or more predetermined operational parameters include a desired pattern for applying the laser beam to the workpiece.

17. The laser welding system of claim 14, wherein the one or more predetermined operational parameters include a power output for the laser source.

18. The laser welding system of claim 11, wherein the one or more weld characteristics include a temperature, size, color, angle, gap, orientation, material thickness, or shape of the weld bead or the workpiece.

19. A collaborative robot laser welding system, comprising:
a laser source to generate laser power to perform a welding operation;
a handheld laser welding torch to direct the laser power to a workpiece; and
a robotic arm to support the handheld laser welding torch;
a laser controller to:
receive a first input from a user corresponding to position or movements of the collaborative robot;
receive a second input corresponding to a welding process; and
control generation of the laser power from the laser source and the positions or the movements of the robotic arm based on the first and second inputs.

20. The collaborative robot laser welding system of claim 19, further comprising a user interface configured to present and receive selection of the first or second inputs, wherein the second input corresponds to a power output for the laser source, a joint type, a workpiece material, a welding application, a wire material, or a welding process.
